(19) United States
(12) Patent Application Publication
(10) Pub. No.: US 2004/0058218 A1
(43) Pub. Date: Mar. 25, 2004

(54) Flow fields with capillarity for solid polymer electrolyte fuel cells

(75) Inventors: Abderrahmane Atbi, Vancouver (CA); David P. Wilkinson, North Vancouver (CA); Olen R. Vanderleeden, Coquitlam (CA); Shanna D. Knights, Burnaby (CA); Andrew Lew, Vancouver (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby (CA)

(21) Appl. No.: 10/251,613

(22) Filed: Sep. 20, 2002

(51) Int. Cl. H01M 8/02; H01M 8/10

(52) U.S. Cl. 429/34; 429/38; 429/30; 429/13

(57) ABSTRACT

Water management is improved in solid polymer electrolyte fuel cells by employing capillary channels or wicks in the lands that separate the reactant distribution channels in the flow fields. Capillary action moves water within these micro-sized capillary channels or wicks. Appropriate designs can be used to assist in the removal of water from the cell and/or in the redistribution of water from relatively wet regions in the cell to relatively dry regions.

### BACKGROUND OF THE INVENTION

1. Field of the Invention

The present invention relates to fluid flow fields for solid polymer electrolyte fuel cells and, more particularly, to flow field designs comprising capillary channels or wicks for purposes of water management.

2. Description of the Related Art

Fuel cell systems show promise for use as power supplies in numerous applications from portable electronics products to automobiles and stationary power plants. In fuel cells, fuel and oxidant reactants are converted to generate electric power and reaction products. Fuel cells generally employ an electrolyte disposed between cathode and anode electrodes. A catalyst typically induces the desired electrochemical reactions at the electrodes. A preferred fuel cell type for many applications is the solid polymer electrolyte (SPE) fuel cell which comprises a solid polymer electrolyte and operates at relatively low temperatures.

During normal operation of a SPE fuel cell, fuel is electrochemically oxidized at the anode catalyst, typically resulting in the generation of protons, electrons, and possibly other species depending on the fuel employed. The protons are conducted from the reaction sites at which they are generated, through the electrolyte, to electrochemically react with the oxidant at the cathode catalyst. The catalysts are preferably located at the interfaces between each electrode and the adjacent electrolyte.

A broad range of fluid reactants can be used in SPE fuel cells and may be supplied in either gaseous or liquid form. For example, the oxidant stream may be substantially pure oxygen gas or a dilute oxygen stream such as air. The fuel may be, for example, substantially pure hydrogen gas, a gaseous hydrogen-containing reformate stream, or an aqueous liquid methanol mixture in the case of a direct methanol fuel cell. Reactants are directed to the fuel cell electrodes and are distributed to catalyst therein by means of fluid diffusion layers. In the case of gaseous reactants, these layers are referred to as gas diffusion layers.

SPE fuel cells employ a membrane electrode assembly (MEA) that comprises the solid polymer electrolyte or ion-exchange membrane disposed between the two electrodes. Each electrode contains a catalyst layer, comprising an appropriate catalyst, located next to the solid polymer electrolyte. The catalyst may, for example, be a metal black, an alloy or a supported metal catalyst, for example, platinum on carbon. The catalyst layer typically contains ionomer which may be similar to that used for the solid polymer electrolyte (e.g., Nafion®). The catalyst layer may also contain a binder, such as polytetrafluoroethylene. The electrodes may also contain a substrate (typically a porous electrically conductive sheet material) that may be employed for purposes of mechanical support and/or reactant distribution, thus serving as a fluid diffusion layer.

The MEA is typically disposed between two plates to form a fuel cell assembly. The plates act as current collectors and provide support for the adjacent electrodes. The assembly is typically compressed to ensure good electrical contact between the plates and the electrodes, in addition to good sealing between fuel cell components. A plurality of fuel cell assemblies may be combined in series or in parallel to form a fuel cell stack. In a fuel cell stack, a plate may be shared between two adjacent fuel cell assemblies, in which case the plate also serves as a separator to fluidly isolate the fluid streams of the two adjacent fuel cell assemblies.

In a fuel cell, flow fields are employed for purposes of directing reactants across the surfaces of the fluid diffusion electrodes or electrode substrates. The flow fields comprise fluid distribution channels separated by “lands” and may be incorporated in the current collector/support plates on either side of the MEA. Such plates are referred to as flow field plates. Alternatively, the flow fields may instead be incorporated in the fluid distribution layers in the MEA. The fluid distribution channels provide passages for the distribution of reactant to the electrode surfaces and also for the removal of reaction products (e.g., water) and depleted reactant streams. The lands act as mechanical supports and provide electrical contact between the fluid diffusion layers and the current collector/separator plates. Thus, flow fields serve a variety of functions and appropriate flow field designs involve a balance of the various related requirements in order to obtain satisfactory results overall.

The amount of water in a SPE fuel cell and its distribution play important roles in fuel cell function. Water reaction product is formed at the cathode and can exist in the liquid phase at typical operating temperatures. The presence of liquid water, however, can undesirably interfere with the access of gases to the catalyst and/or with the flow of gases in the flow fields (by flooding). The liquid water within the cell may not be distributed uniformly since water reaction product is typically not generated evenly over the active electrode area (due to variations in local reactant concentrations) and water is typically concentrated in the exhaust by the flowing reactant streams. While too much liquid water can therefore be undesirable, the solid polymer electrolyte needs to remain well hydrated in order to provide high ionic conductivity. There is a drying tendency generally in the vicinity of the anode because water is continually transferred from anode to cathode across the electrolyte along with protons formed in the fuel cell reactions. There may also be a drying tendency in the vicinity of the reactant inlets generally since water and any other reaction species are swept away by the incoming reactant streams and since the inlet streams may have lower relative humidity. Thus, water is typically provided to (e.g., by supplying humidified reactants) or redistributed within the fuel cell continually to prevent the membrane electrolyte from drying out.

Achieving an appropriate water balance under non-uniform conditions for these competing requirements poses a considerable challenge. Various methods for achieving this balance and/or improving uniformity have been suggested. For instance, U.S. Pat. No. 5,952,119 is directed to the use of hydrophilic threads in the gas diffusion backing and water distribution channels in the anode flow field plate. Therein, the water distribution channels are separate from the fuel distribution channels in order to uniformly provide water to the membrane independent of reactant flow rate. Alternatively, published PCT WO00/26981 is directed to the use of microstructured flow fields in which microgrooves may be formed in the base of the reactant fluid distribution channels for water redistribution or removal.

While advances have been made with regard to fluid flow fields for SPE fuel cells, there remains a need in the art for improved designs for purposes of water management. The present invention fulfills this need and provides further related advantages.

### BRIEF SUMMARY OF THE INVENTION

Water balance and uniformity in SPE fuel cells may be improved by the use of capillary channels or wicks in the lands of one or more flow fields in SPE fuel cells. The presence of capillary channels or wicks may effect water distribution as water condenses in first ends of the capillary channels/wicks and moves towards second ends of the capillary channels/wicks by capillary action. In this manner, water may be redistributed or removed from the fuel cell as desired.

The flow field supplies a fluid reactant to a fluid diffusion electrode in the SPE fuel cell and comprises at least one reactant distribution channel and lands which separate portions of the reactant distribution channel. For instance, the flow field may comprise a single serpentine reactant distribution channel with lands separating traverses of the distribution channel, or may comprise multiple distribution channels with lands separating the individual channels. Also, the flow field may comprise interdigitated channels with lands separating channels that are not continuously connected to both the inlet and outlet reactant ports. The flow field further comprises at least one capillary channel or wick in the surface of these lands.

When capillary channels are employed, they are sized so as to effect the desired capillary action while the reactant distribution channels are sized substantially larger for reactant distribution. As such, the ratio of the average hydraulic diameter of the capillary channel or channels to that of the reactant distribution channel or channels is less than 0.1. The average hydraulic diameter of the capillary channel is typically less than 100 micrometers. The average hydraulic diameter of the reactant distribution channel(s), although larger than that of the capillary channels, is typically less than 1000 micrometers.

In a like manner, when wicks are employed, the wicking material is selected so as to effect the desired capillary action. Suitable wicking materials may include polyvinylalcohols, cotton, thread coated with Nafion® and the like.

The use of capillary channels or wicks is particularly effective in the oxidant (cathode) flow field since the water content is typically greater on the cathode side than on the anode side. The flow field may be comprised within a separator plate or a gas diffusion layer in the SPE fuel cell.

In one embodiment, a plurality of capillary channels may be employed that are connected at one end to a reactant distribution channel. In particular, the plurality of channels may be configured to form a herringbone pattern. Such an embodiment may be useful in augmenting the removal of water from the fuel cell.

In another embodiment, the flow field may comprise a plurality of essentially parallel reactant distribution channels and a plurality of essentially parallel capillary channels in the surface of the lands separating these reactant distribution channels. The ends of the capillary channels may be closed. Such an embodiment may be useful in redistributing water from a wetter end of the flow field (e.g., the oxidant outlet) to a drier end of the flow field (e.g., the oxidant inlet). Alternatively the capillary channels may be connected at one end to a port in order to direct water to the port.

Other embodiments employing wicks instead of capillary channels or combining these or other features are also within the scope of this invention.

### BRIEF DESCRIPTION OF THE DRAWINGS

FIG. 1 is a schematic diagram of a prior art solid polymer electrolyte fuel cell stack.

FIG. 2a shows an oxidant flow field plate comprising parallel oxidant distribution channels and capillary channels connected thereto.

FIG. 2b shows an oxidant flow field plate comprising two serpentine oxidant distribution channels and capillary channels connected thereto.

FIG. 3a shows a top view of an oxidant flow field plate comprising parallel oxidant distribution channels and parallel capillary channels in the surface of the lands separating the oxidant distribution channels.

FIG. 3b shows a cross section of the oxidant flow field plate along section A-A of FIG. 3a.

### DETAILED DESCRIPTION OF THE INVENTION

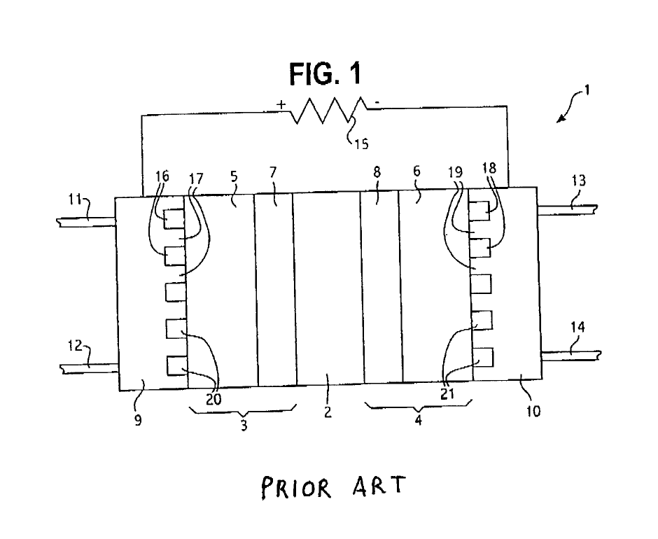

A schematic diagram of a prior art solid polymer fuel cell stack is depicted in FIG. 1. For simplicity, FIG. 1 shows only one cell in the fuel cell stack. Fuel cell 1 comprises a membrane electrode assembly consisting of solid polymer electrolyte membrane 2 sandwiched between cathode 3 and anode 4. Cathode 3 comprises porous fluid diffusion layer 5 and catalyst layer 7. Anode 4 comprises porous fluid diffusion layer 6 and catalyst layer 8. Fluid diffusion layers 5, 6 serve as electrically conductive backings and mechanical supports for catalyst layers 7, 8. Fluid diffusion layers 5, 6 also serve to distribute fluid reactants from flow field plates 9, 10 to catalyst layers 7, 8. During operation, oxidant and fuel are supplied to flow field plates 9 and 10 respectively at inlets 11 and 13 respectively. The oxidant and fuel streams exhaust from fuel cell 1 at outlets 12 and 14 respectively. Flow field plates 9, 10 comprise flow fields with reactant distribution channels 16, 18, which deliver reactants directly to surfaces of diffusion layers 5, 6. Flow field plates 9, 10 also comprise lands 17, 19 which form the walls of channels 16, 18 and which mechanically support diffusion layers 5, 6. During operation, power is delivered to a load depicted as resistor 15.

The distribution of water in fuel cell 1 can be modified by incorporating suitable capillary channels in lands 17, 19. Liquid water entering a capillary channel or water vapor condensed in a capillary channel at one location can be moved by capillary action to another location. Thus, capillary channels may be employed to assist in water removal or to distribute water more uniformly throughout fuel cell 1. Typically, water concentrations are greatest on the cathode side of fuel cell 1 and thus modifications to oxidant flow field plate 9 may be more effective. However, capillary channels may be incorporated in either or both of flow field plates 9, 10.

Reactant distribution channels in flow field plates 9, 10 have depth and width dimensions typically about 1000 micrometers or less and hence, when mated to an adjacent diffusion layer, also have hydraulic diameters typically about 1000 micrometers or less. (The hydraulic diameter of a pipe or channel is defined as 4 times the cross-sectional area divided by the wetted perimeter. Thus, the hydraulic diameter of a circular pipe is simply the pipe diameter.)

In embodiments of the invention, the capillary channels have dimensions that are substantially smaller than that of the reactant channels (e.g., by a factor of 10 or more) and are effective for moving water by capillary action. Thus, the capillary channels have dimensions about 100 micrometers or less and hence, when mated to an adjacent diffusion layer, have hydraulic diameters about 100 micrometers or less. The dimensions of the capillary channels employed in any given embodiment may vary according to factors that affect capillary force and flow (e.g., pressure, temperature, surface condition of channels), manufacturing considerations, and the like.

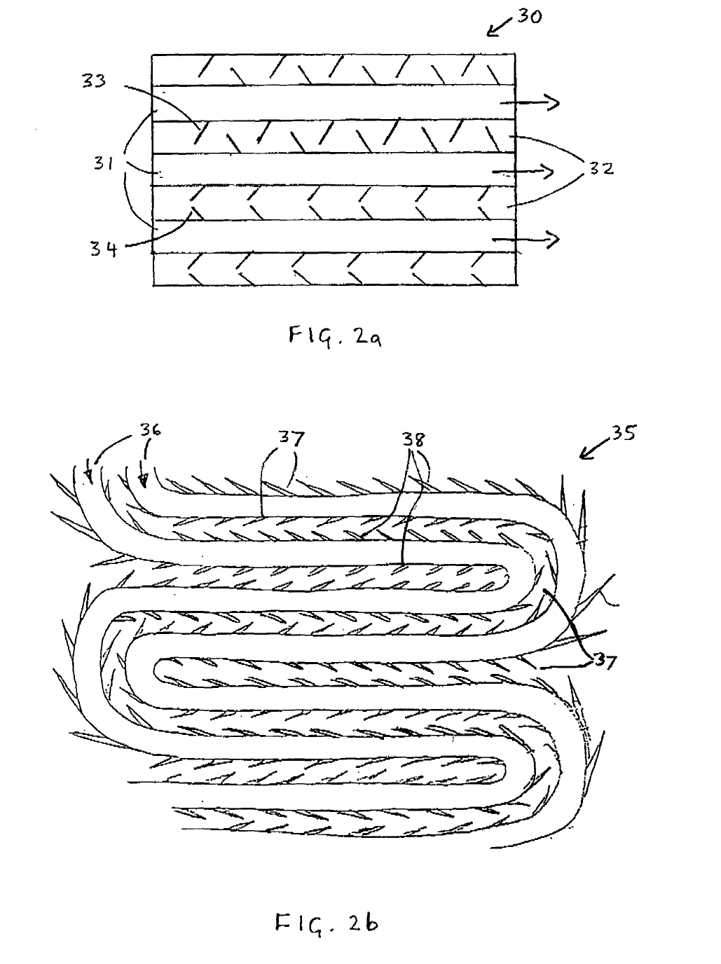

FIG. 2a shows an embodiment of the invention for assisting in water removal from the fuel cell. Oxidant flow field plate 30 comprises multiple parallel oxidant distribution channels 31 and lands 32. A plurality of capillary channels 33, 34 are formed in lands 32 and are connected at one end to distribution channels 31. The direction of flow of the oxidant in distribution channels 31 is shown by arrows. Liquid water in the vicinity of lands 32 may enter capillary channels 33, 34 or alternatively water vapor in the vicinity of lands 32 may condense in capillary channels 33, 34. In either case, the water is carried by capillary action towards the larger distribution channels 31, is drawn into them by a venturi effect (created by the flow of oxidant in channels 31), and is then swept away in the oxidant stream. FIG. 2a shows two representative configurations for the capillary channels, namely a staggered configuration for capillary channels 33 and a herringbone configuration for capillary channels 34. In the former, the capillary channels may extend over most of the width of lands 32, while in the latter, they may extend up to half of the land width. The capillary channels may be tapered in width or in depth (e.g., wider and/or deeper where they connect to distribution channels 31). Further, there may be a non-uniform distribution of capillary channels over lands 32. For instance, it may be desirable to incorporate more capillary channels per unit of land surface in the exhaust area of oxidant flow field plate 30 where the amount of water is greater.

FIG. 2b shows a similar embodiment to that of FIG. 2a except that oxidant flow field plate 35 comprises two serpentine oxidant distribution channels 36 and lands 37. A plurality of capillary channels 38 are formed in lands 37 and are connected at one end to distribution channels 36.

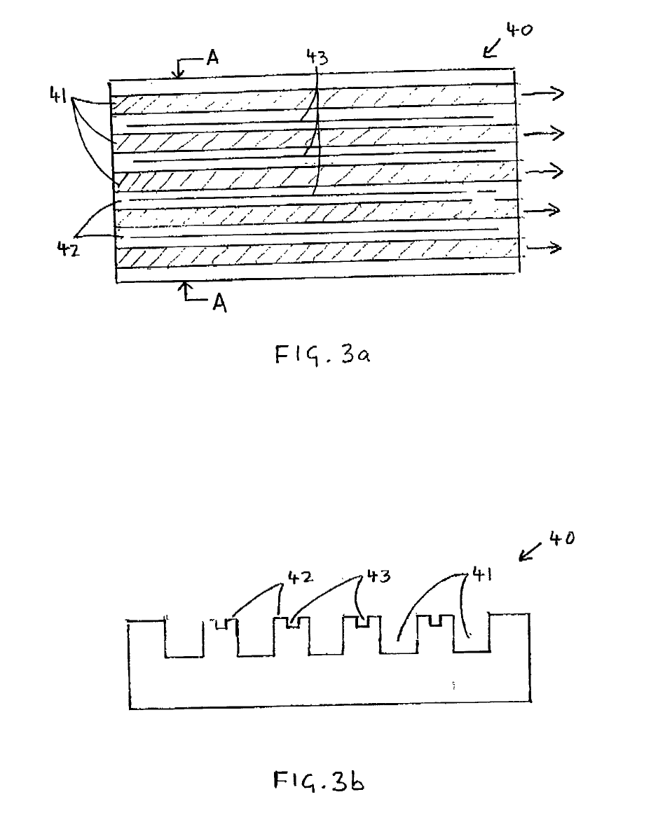

FIG. 3a shows a top view of an embodiment of the invention for redistributing water within the fuel cell. FIG. 3b shows a cross section of the embodiment in FIG. 3a along section A-A. Oxidant flow field plate 40 comprises multiple parallel oxidant distribution channels 41 and lands 42. A plurality of dead-ended capillary channels 43 are formed in lands 42 and extended over most of the length of flow field plate 40. The direction of flow of the oxidant in distribution channels 41 is shown by arrows. In a typical SPE fuel cell, there may be an excessive amount of water in the vicinity of the oxidant exhaust while it may be undesirably dry in the vicinity of the oxidant inlet. Thus, water may be moved by capillary action in channels 43 from the exhaust area to the inlet area where it evaporates. Thus, capillary channels 43 may serve to redistribute water from outlet to inlet within the fuel cell. Alternatively, the drier ends of the capillary channels may be connected to a port of some sort (not shown) to provide for the removal of water from the fuel cell (water removal may be vacuum assisted).

The preceding Figures illustrate several oxidant flow field plates that advantageously employ capillary channels in the lands. However, various other flow field patterns may be contemplated that combine the advantages of the preceding with other desirable features. Further, suitable wicks may be employed instead of capillary channels.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings.

What is claimed is:

1. A flow field for supplying a fluid reactant to a fluid diffusion electrode in a solid polymer electrolyte fuel cell, the flow field comprising at least one reactant distribution channel, lands separating portions of the reactant distribution channel, and capillary means in the surface of the lands separating the reactant distribution channel portions.

2. The flow field of claim 1 wherein the capillary means comprises at least one capillary channel and the ratio of the average hydraulic diameter of the capillary channel to that of the reactant distribution channel is less than 0.1.

3. The flow field of claim 2 comprising a plurality of capillary channels in the surface of the lands.

4. The flow field of claim 3 comprising a plurality of reactant distribution channels.

5. The flow field of claim 2 wherein the average hydraulic diameter of the capillary channel is less than 100 micrometers.

6. The flow field of claim 2 wherein the average hydraulic diameter of the reactant distribution channel is less than 1000 micrometers.

7. The flow field of claim 3 wherein the plurality of capillary channels are connected at one end to the reactant distribution channel.

8. The flow field of claim 7 wherein the reactant distribution channel and connected capillary channels form a herringbone pattern.

9. The flow field of claim 2 comprising a plurality of essentially parallel reactant distribution channels and a plurality of essentially parallel capillary channels in the surface of the lands separating the reactant distribution channels.

10. The flow field of claim 9 wherein the ends of the capillary channels are closed.

11. The flow field of claim 9 wherein at least one end of the capillary channels is connected to a port.

12. The flow field of claim 1 wherein the capillary means comprises a wick.

13. The flow field of claim 1 wherein the fluid reactant is oxidant and the flow field is an oxidant flow field.

14. The flow field of claim 1 wherein the fluid reactant is fuel and the flow field is a fuel flow field.

15. A solid polymer fuel cell comprising the flow field of claim 1.

16. The solid polymer fuel cell of claim 15 wherein the flow field is comprised within a separator plate.

17. The solid polymer fuel cell of claim 15 wherein the flow field is comprised within a gas diffusion layer.

18. A method for distributing water in a solid polymer electrolyte fuel cell, the fuel cell comprising a flow field for supplying a fluid reactant to a fluid diffusion electrode in the fuel cell, the flow field comprising at least one reactant distribution channel and lands separating portions of the reactant distribution channel, wherein the method comprises introducing at least one capillary channel in the surface of the lands separating the reactant distribution channel portions such that water condenses in a first end of the capillary channel and moves towards a second end of the capillary channel by capillary action.

19. The method of claim 18 wherein the ratio of the average hydraulic diameter of the capillary channel to that of the reactant distribution channel is less than 0.1.

20. The method of claim 19 wherein the second end of the capillary channel is connected to the reactant distribution channel.

21. The method of claim 18 wherein the flow field is an oxidant flow field.

22. The method of claim 21 wherein the first end of the capillary channel is located near the oxidant outlet and the second end is located near the oxidant inlet.

23. The method of claim 18 wherein the flow field comprises a plurality of capillary channels.

24. A method for distributing water in a solid polymer electrolyte fuel cell, the fuel cell comprising a flow field for supplying a fluid reactant to a fluid diffusion electrode in the fuel cell, the flow field comprising at least one reactant distribution channel and lands separating portions of the reactant distribution channel, wherein the method comprises introducing a wick in the surface of the lands separating the reactant distribution channel portions such that water condenses in a first end of the wick and moves towards a second end of the wick by capillary action.

25. The method of claim 24 wherein the second end of the wick is connected to the reactant distribution channel.

26. The method of claim 24 wherein the flow field is an oxidant flow field.

27. The method of claim 26 wherein the first end of the wick is located near the oxidant outlet and the second end is located near the oxidant inlet.

28. The method of claim 24 wherein the flow field comprises a plurality of wicks.
